(19) United States
(12) Patent Application Publication
(10) Pub. No.: US 2025/0392027 A1
(43) Pub. Date: Dec. 25, 2025

(54) METHOD AND APPARATUS FOR MANUFACTURING BATTERY CELL

(71) Applicant: SK On Co., Ltd., Seoul (KR)

(72) Inventors: Jun Hui JEONG, Daejeon (KR); Seung Hyeon CHEON, Daejeon (KR); Da Eun KIM, Daejeon (KR)

(21) Appl. No.: 19/227,515

(22) Filed: Jun. 4, 2025

(30) Foreign Application Priority Data
Jun. 19, 2024 (KR) 10-2024-0079807

(51) Int. Cl. H01M 50/609; H01M 10/04

(52) U.S. Cl. CPC H01M 50/609; H01M 10/0404

(57) ABSTRACT

A method of manufacturing a battery cell includes an operation of injecting electrolyte into a case accommodating an electrode assembly, through an injection port, a degassing operation of discharging gas inside the case, and an injection port sealing operation of sealing the injection port. At least a portion of the degassing operation and the injection port sealing operation are performed inside a chamber under a negative pressure state, lower than atmospheric pressure.

### CROSS-REFERENCE TO RELATED APPLICATION(S)

This patent document claims the priority and benefits of Korean Patent Application No. 10-2024-0079807 filed on Jun. 19, 2024, the disclosure of which is incorporated herein by reference in its entirety.

### TECHNICAL FIELD

The disclosure and implementations disclosed in this patent document generally relate to a method and apparatus for manufacturing a secondary battery cell capable of being charged and discharged.

### BACKGROUND

A secondary battery cell is an energy storage means that may be charged with and discharged. Secondary battery cells are widely used in various means that use electricity as a power source. For example, secondary battery cells are used in various fields ranging from small devices such as mobile phones, laptops, and tablets to vehicles, energy storage devices and the like.

A battery cell may include a case (for example, a can, a pouch, or the like) and an electrode assembly. The electrode assembly includes a cathode, an anode, and a separator, and may be accommodated inside the case. An electrolyte may be injected into the case through an injection port while the electrode assembly is accommodated inside the case.

During the manufacturing process of the battery cell, the injection port may be sealed to prevent loss of the electrolyte accommodated inside the case and to prevent moisture from penetrating into the case from the outside.

### SUMMARY

To seal the injection port, a sealing plug, such as a sealing ball or a sealing pin, may be installed in the injection port. For example, the injection port may be formed in a cap plate covering the case. The sealing plug may be installed in the injection port mostly by a forced fit or a press fit.

Before installing the sealing plug in the injection port, the battery cell undergoes a pre-charging process, an aging process, or the like. During this process, the electrode assembly may expand and/or gas may be generated inside the battery cell, and thus the internal pressure of the battery cell may be increased.

If the sealing plug is forced or press-fitted into the injection port, the internal pressure of the battery cell may increase, which may deform the external shape of the battery cell. Accordingly, not only may the performance of the battery cell be degraded, but also the assembling efficiency may be degraded during the process of arranging the battery cells to form a cell assembly.

The present disclosure can be implemented in some embodiments to provide a method and apparatus for manufacturing a battery cell, in which deformation of a battery cell may be prevented or reduced during the process of sealing an injection port.

According to an aspect of the present disclosure, a method and apparatus for manufacturing a battery cell may be provided, in which a battery cell satisfying design dimensions may be manufactured.

According to an aspect of the present disclosure, a method and apparatus for manufacturing a battery cell may be provided that may simplify a manufacturing process of a battery cell.

A battery cell manufactured by the method and apparatus for manufacturing a battery cell according to an aspect of the present disclosure may be widely applied in green technology fields such as electric vehicles, battery charging stations, and other solar power generation and wind power generation using batteries. In addition, a battery cell manufactured by the method and apparatus for manufacturing a battery cell according to an aspect of the present disclosure may be used in eco-friendly electric vehicles, hybrid vehicles, and the like to prevent climate change by suppressing air pollution and greenhouse gas emissions.

In some embodiments of the present disclosure, a method of manufacturing a battery cell includes an operation of injecting electrolyte into a case accommodating an electrode assembly, through an injection port; a degassing operation of discharging gas inside the case; and an injection port sealing operation of sealing the injection port. At least a portion of the degassing operation and the injection port sealing operation are performed inside a chamber under a negative pressure state, lower than atmospheric pressure.

In an embodiment, the injection port sealing operation may be performed continuously with the degassing operation inside the chamber, and the injection port sealing operation may be performed at a pressure higher than a final than pressure of the degassing operation and lower atmospheric pressure.

In an embodiment, the degassing operation may include a process performed under a first negative pressure state, lower than atmospheric pressure, and the injection port sealing operation may be performed under a second negative pressure state, higher than a minimum pressure of the first negative pressure state and lower than atmospheric pressure.

In an embodiment, in the degassing operation, pressure inside the chamber may have a value of 10 torr to atmospheric pressure, and in the injection port sealing operation, the pressure inside the chamber may have a value of 100 to 700 torr.

In an embodiment, the pressure inside the chamber in the degassing operation may be controlled in multiple stages.

In an embodiment, the injection port sealing operation may include a process of installing a sealing plug in the injection port.

In an embodiment, the method of manufacturing a battery cell may further comprise an injection port cover installation operation of covering the sealing plug with an injection port cover.

According to an embodiment, the degassing operation and the injection port sealing operation may be performed with the case being located inside the chamber.

In some embodiments of the present disclosure, an apparatus for manufacturing a battery cell includes a chamber accommodating a battery cell therein; a pressure regulator regulating a flow of gas to control pressure inside the chamber; a sealing plug installer covering an injection port of the battery cell with a sealing plug; and a controller controlling an operation of the pressure regulator and the sealing plug installer. The controller controls the operation of the pressure regulator such that the pressure inside the chamber becomes a negative pressure state, lower than atmospheric pressure during at least a portion of the degassing operation of discharging gas inside the battery cell and the injection port sealing operation of installing the sealing plug.

In an embodiment, the controller may control the injection port sealing operation to be performed continuously with the degassing operation, and the controller may control the operation of the pressure regulator so that the injection port sealing operation is performed at a pressure at which the pressure inside the chamber is higher than a final pressure of the degassing operation and lower than atmospheric pressure.

In an embodiment, the controller may control the operation of the pressure regulator so that the pressure inside the chamber is in a first negative pressure state, lower than atmospheric pressure, in the degassing operation, and control the operation of the pressure regulator so that the pressure inside the chamber is in a second negative pressure state, higher than a minimum pressure of the first negative pressure state and lower than atmospheric pressure in the injection port sealing operation.

In an embodiment, the controller may control the operation of the pressure regulator so that the pressure inside the chamber has a value of 10 torr to atmospheric pressure in the degassing operation, and the controller may control the operation of the pressure regulator so that the pressure inside the chamber has a value of 100 to 700 torr in the injection port sealing operation.

### BRIEF DESCRIPTION OF DRAWINGS

Certain aspects, features, and advantages of the present disclosure are illustrated by the following detailed description with reference to the accompanying drawings.

FIG. 1 is a perspective view of a battery cell according to an embodiment.

FIG. 2 is a flow chart illustrating a method of manufacturing a battery cell according to an embodiment.

FIG. 3 is a schematic diagram illustrating an electrolyte injection operation.

FIG. 4 is a schematic diagram of an apparatus for manufacturing a battery cell, illustrating a degassing operation.

FIG. 5 is a schematic diagram of an apparatus for manufacturing a battery cell, illustrating an injection port sealing operation.

FIGS. 6A to 6C are schematic diagrams illustrating the shapes of a case according to pressure in the injection port sealing operation.

FIG. 7 is a schematic diagram illustrating a state in which an injection port cover is installed in an injection port.

### DETAILED DESCRIPTION

Features of the present disclosure disclosed in this patent document are described by example embodiments with reference to the accompanying drawings.

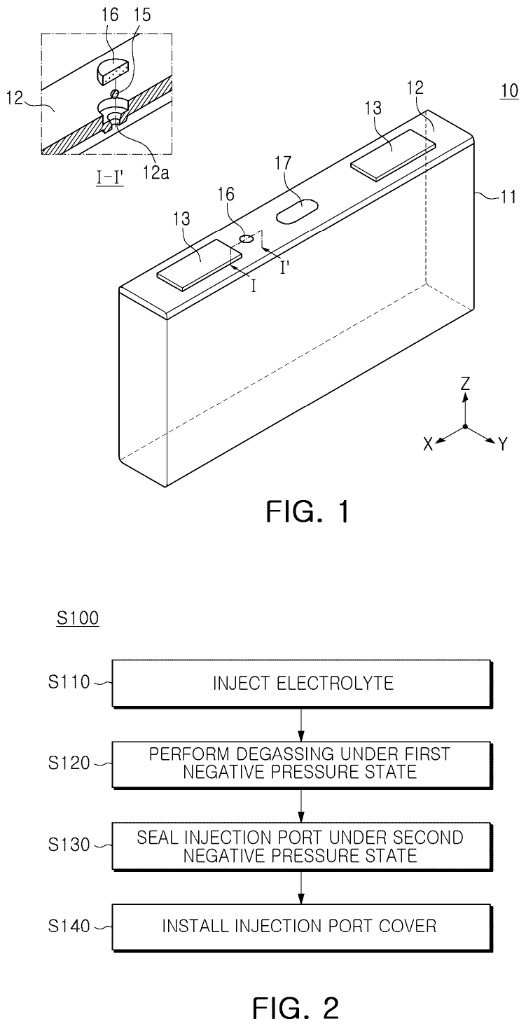

First, an example of a battery cell 10 manufactured by a method and apparatus for manufacturing a battery cell according to an embodiment of the present disclosure will be described with reference to FIG. 1.

In the present disclosure, a prismatic cell is exemplified as a battery cell 10. The prismatic cell may be classified into a unidirectional cell (see FIG. 1) in which electrode terminals 13 of different polarities are disposed together on one side of a case 11, and a bidirectional cell in which electrode terminals 13 of different polarities are disposed on both sides of the case 11, and the present disclosure may be applied to various prismatic cells including unidirectional cells and bidirectional cells.

A method and apparatus for manufacturing a battery cell according to an embodiment is not limited to being applied to prismatic cells, and may also be applied to cylindrical cells or coin-shaped cells. In addition, a method and apparatus for manufacturing a battery cell according to an embodiment does not exclude being applied to pouch-shaped cells.

FIG. 1 is a perspective view of a battery cell 10 according to an embodiment. FIG. 1 illustrates a partial cross-section taken along line I-I′ to illustrate components around an injection port 12a.

The battery cell 10 according to an embodiment may be configured as a secondary battery. In the present disclosure, the battery cell 10 is described as being a prismatic battery cell, but the shape of the battery cell 10 is not limited to a hexahedral structure.

The battery cell 10 may include a case 11, a cap plate 12, and an electrode assembly 14.

The case 11 may form the appearance of the battery cell 10. As an example, the case 11 of a prismatic type battery cell 10 may have a hexahedral shape. An internal space may be formed in the case 11, and an opening may be formed in at least one side of the case 11.

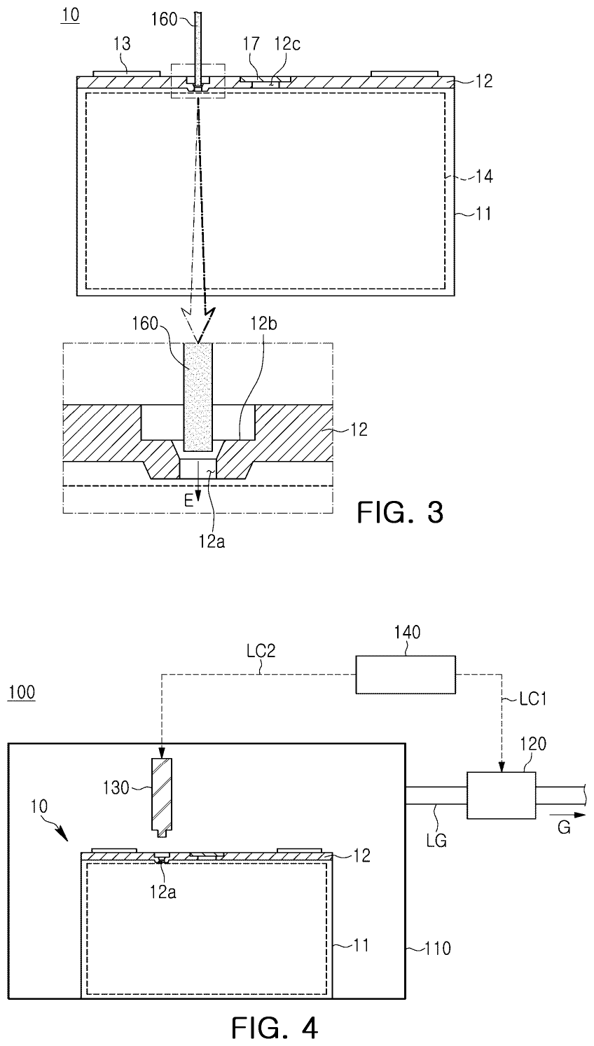

The cap plate 12 may be coupled to the opening of the case 11. The cap plate 12 may be formed with an injection port 12a for injecting electrolyte and a venting hole (12c in FIG. 3) through which gas inside the battery cell 10 is discharged to the outside when the internal pressure of the battery cell 10 increases.

An electrode assembly 14 (see FIG. 3) and an electrolyte may be accommodated in the internal space of the case 11. The electrode assembly 14 may include a plurality of electrode plates and a plurality of separators. The electrode plates may include a cathode plate and an anode plate. The separator may be composed of an insulator interposed between the anode plate and the cathode plate. The electrode assembly 14 may be composed of a stack type in which the anode plate, the cathode plate, and the separator are alternately stacked, or a jelly roll type in which the stacked anode plate, cathode plate and separator are rolled together.

An electrode terminal 13 electrically connected to an electrode assembly 14 may be installed on the cap plate 12. As an example, the electrode terminal 13 may include a cathode terminal electrically connected to a cathode plate of the electrode assembly 14 and an anode terminal electrically connected to an anode plate.

A sealing plug 15 may be installed in the injection port 12a of the cap plate 12. The sealing plug 15 may seal the injection port 12a to prevent loss of electrolyte. For example, the sealing plug 15 may include a sealing ball or a sealing pin. An injection port cover 16 covering the sealing plug 15 may be installed to more stably seal the injection port 12a.

A vent cover 17 may be installed in the venting hole 12c of the cap plate 12. The vent cover 17 may be configured to be ruptured when the internal pressure of the battery cell 10 becomes greater than a preset pressure. Accordingly, gas inside the battery cell 10 may be discharged to the outside of the case 11 through the venting hole 12c.

Referring to FIGS. 2 to 7 together with FIG. 1, a method of manufacturing a battery cell (S100) is described.

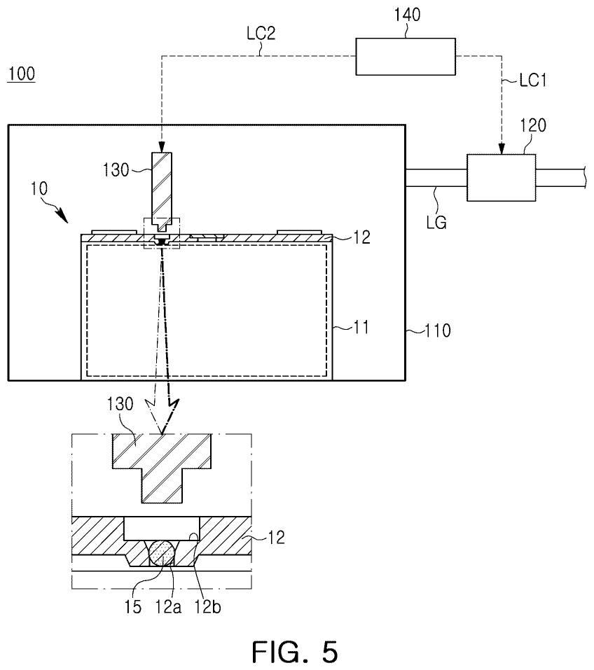

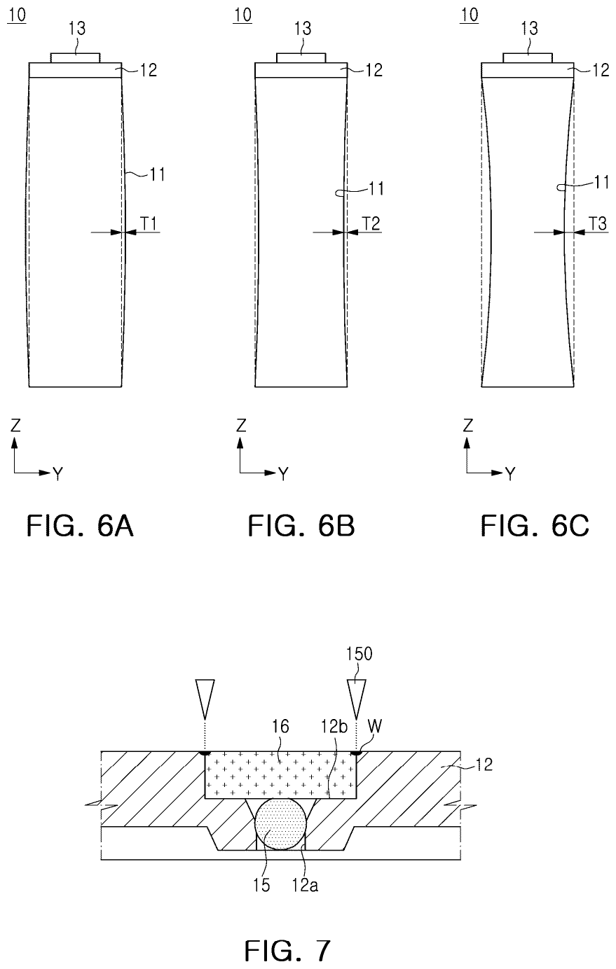

FIG. 2 is a flow chart illustrating a method of manufacturing a battery cell (S100) according to an embodiment. FIG. 3 is a schematic diagram illustrating an electrolyte injection operation (S110), and FIG. 4 is a schematic diagram of an apparatus 100 for manufacturing a battery cell, illustrating a degassing operation (S120). FIG. 5 is a schematic diagram of an apparatus 100 for manufacturing a battery cell, illustrating an injection port sealing operation (S130), and FIGS. 6A to 6C are schematic diagrams illustrating the shape of a case 11 according to pressure in the injection port sealing operation (S130). FIG. 7 is a schematic diagram illustrating a state in which an injection port cover 16 is installed in an injection port 12a.

Referring to FIG. 2, a method of manufacturing a battery cell (S100) according to an embodiment may include an operation (S110) of injecting electrolyte through an injection port 12a into a case 11 accommodating an electrode assembly 14 therein, a degassing operation (S120) of discharging gas inside the case 11, and an injection port sealing operation (S130) of sealing the injection port 12a. At least a portion of the degassing operation (S120) and the injection port sealing operation (S130) may be performed inside a chamber (110 of FIG. 4) under a negative pressure lower than atmospheric pressure. A method of manufacturing a battery cell (S100) according to an embodiment may additionally include an injection port cover installation operation (S140) of covering a sealing plug 15 with an injection port cover 16.

Referring to FIG. 3, the battery cell 10 may have a shape in which the opening of the case 11 is covered with a cap plate 12 while the electrode assembly 14 is accommodated inside the case 11. The cap plate 12 may include an injection port 12a for injecting electrolyte (E), and a venting hole 12c for discharging gas inside the case 11. The venting hole 12c may be blocked by a vent cover 17. The cap plate 12 may include a step portion 12b disposed above the injection port 12a. An injection port cover 16 may be mounted on the step portion 12b.

In the electrolyte injection operation (S110), electrolyte may be injected into the case 11 in which the electrode assembly 14 is accommodated, through the injection port 12a. In the electrolyte injection operation (S110), the injection port 12a may be open. A liquid injector 160 may be used to inject the electrolyte. In the electrolyte injection operation (S110), the liquid injector 160 may approach the injection port 12a formed in the cap plate 12 and inject a preset amount of electrolyte (E) into the case 11 through the injection port 12a. When the injection of the electrolyte (E) is completed, the liquid injector 160 may be moved away from the injection port 12a. The electrolyte injection operation (S110) may be performed in a dry room controlled to a low moisture state, but may also be performed in a general outdoor state. In addition, the electrolyte injection operation (S110) may also be performed inside a chamber (110 of FIG. 4) under a negative pressure state.

After injecting electrolyte into the battery cell 10, a pre-charging process, an aging process, and the like may be performed. When the pre-charging process and/or the aging process are performed, the electrode assembly 14 expands and/or gas is generated inside the battery cell 10, and accordingly, the internal pressure of the battery cell 10 may be increased.

The degassing operation (S120) may discharge gas inside the case 11. The degassing operation (S120) may discharge gas generated inside the battery cell 10 while performing the pre-charging process, aging process, or the like to the outside. Through the degassing operation (S120), the impregnation property of the electrolyte may be improved by removing gas (bubbles) inside the electrode assembly 14, and the inactive portion of the electrode may be reduced, thereby increasing the capacity of the battery cell 10.

Referring to FIG. 4, the degassing operation (S120) may be performed inside a chamber 110 that accommodates a battery cell 10. The chamber 110 may include a vacuum chamber capable of implementing a high vacuum. The internal pressure of the chamber 110 may be controlled. A pressure regulator 120 may be connected to the chamber 110 to control the pressure inside the chamber 110. The pressure regulator 120 may include a vacuum pump that discharges gas (including air) (G) inside the chamber 110 to the outside. The pressure regulator 120 may include a gas supplier that supplies gas inside the chamber 110 to control the pressure inside the chamber 110. The pressure regulator 120 may be connected to the inside of the chamber 110 through a gas flow line (LG). The pressure regulator 120 may be controlled to be driven by a controller 140. The controller 140 may control the operation of the sealing plug installer 130 as well as the pressure regulator 120. The controller 140 may control the operation of the pressure regulator 120 through the first control line LC1 and control the operation of the sealing plug installer 130 through the second control line LC2.

At least a portion of the degassing operation (S120) may be performed inside the chamber 110 at a negative pressure state, lower than the atmospheric pressure. For example, the degassing operation (S120) may be continuously performed inside the chamber 110 at a negative pressure state, lower than the atmospheric pressure. The degassing operation (S120) may be performed inside the chamber 110 at a negative pressure state, lower than the atmospheric pressure. The degassing operation (S120) may remove gas inside the battery cell 10 at a negative pressure state. In contrast, in the degassing operation (S120), the pressure inside the chamber 110 may be changed from a vacuum state of negative pressure to atmospheric pressure where the vacuum is broken, and then changed back to a negative pressure state. In other words, some processes in the degassing operation (S120) may include a process of returning from a negative pressure state to atmospheric pressure (or normal pressure).

In the degassing operation (S120), the pressure inside the chamber 110 may be controlled in multiple stages. If the pressure inside the chamber 110 is rapidly changed from atmospheric pressure (for example, 760 torr) or a pressure (for example, 750 torr) slightly lower than the atmospheric pressure to a high vacuum pressure (for example, 50 torr), a rapid pressure change may occur inside the battery cell 10, which may cause damage to the electrode assembly 14, and also, electrolyte may be discharged outside the case 11. Accordingly, in the degassing operation (S120), the pressure inside the chamber 110 may be decompressed in two or more stages. For example, the pressure inside the chamber 110 may be lowered from an initial pressure (for example, atmospheric pressure of 760 torr) to a first pressure (for example, 300 torr) lower than the initial pressure, the pressure inside the chamber 110 may be maintained at the first pressure for a predetermined period of time, and thereafter, the pressure inside the chamber 110 may be decompressed again to a second pressure (for example, 50 torr) lower than the first pressure. The pressure stages inside the chamber 110 in the degassing operation (S120) may also be composed of three or more, and the pressure value inside the chamber 110 of each stage may also be variously changed. The number of decompressing stages and the pressure value may be changed depending on the design specifications of the battery cell 10, or the like.

In addition, the degassing operation (S120) may be configured to reduce the pressure inside the chamber 110 from the initial pressure (for example, atmospheric pressure) to a negative pressure lower than the atmospheric pressure, and then return to the initial pressure, and then reduce the pressure again in multiple stages. For example, the degassing operation (S120) may reduce the pressure inside the chamber 110 from the initial pressure (for example, 760 torr) to a lower pressure (for example, 600 torr) to stabilize the battery cell 10, and then return to the initial pressure. Thereafter, the degassing operation (S120) may perform the operation of reducing the pressure inside the chamber 110 in two or more stages again.

The injection port sealing operation (S130) may seal the injection port 12a. By sealing the injection port 12a, loss of electrolyte contained inside the case 11 may be prevented and moisture infiltration into the case 11 from the outside may be prevented.

Referring to FIG. 5, the injection port sealing operation (S130) may be performed inside the chamber 110 in which the degassing operation (S120) is performed.

The injection port sealing operation (S130) may include a process of installing a sealing plug 15 in the injection port 12a. The process of installing the sealing plug 15 may include a process of supplying the sealing plug 15 to the injection port 12a and disposing it, and a process of forcibly fitting or press-fitting the sealing plug 15 into the injection port 12a. The sealing plug 15 may include a sealing ball or sealing pin installed in the injection port 12a to seal the injection port 12a. The injection port sealing operation (S130) may be performed by a sealing plug installer 130. The sealing plug installer 130 may approach the injection port 12a and supply the sealing plug 15 to the injection port 12a. With the sealing plug 15 positioned in the injection port 12a, the sealing plug installer 130 may forcefully fit or press the sealing plug 15 into the injection port 12a. Accordingly, the sealing plug 15 may seal the injection port 12a and block the internal space of the battery cell 10 to the outside. After the installation of the sealing plug 15 is completed, the sealing plug installer 130 may move away from the injection port 12a.

The injection port sealing operation (S130) may be performed inside a chamber 110 under a negative pressure state, lower than the atmospheric pressure. At least a portion of the degassing operation (S120) and the injection port sealing operation (S130) may be performed inside the chamber 110 at a negative pressure lower than the atmospheric pressure.

The injection port sealing operation (S130) may be performed continuously with the degassing operation (S120) inside the chamber 110. For example, the injection port sealing operation (S130) may be started at the end point of the degassing operation (S120).

The degassing operation (S120) and the injection port sealing operation (S130) may be performed while the case 11 is located inside the chamber 110. For example, the injection port sealing operation (S130) may be performed subsequent to the degassing operation (S120) while the case 11 is located inside the chamber 110.

The injection port sealing operation (S130) may be performed at a pressure higher than the final pressure of the degassing operation (S120) and lower than the atmospheric pressure. The degassing operation (S120) is completed in a state where the inside of the chamber 110 has a high vacuum degree, and the injection port sealing operation (S130) may be performed in a state where the inside of the chamber 110 has a lower vacuum degree than the degassing operation (S120). For example, in the case in which the final pressure of the degassing operation (S120) is 100 torr, the injection port sealing operation (S130) may be performed at 400 torr.

If the degassing operation (S120) is completed in a high vacuum state, the injection port sealing operation (S130) may be performed in a medium vacuum state. The degassing operation (S120) discharges gas inside the case 11 in a high vacuum state, and accordingly, the case 11 may be changed to a concave shape. The injection port sealing operation (S130) may seal the injection port 12a in a vacuum state that satisfies the design dimensions of the battery cell 10. In the injection port sealing operation (S130), the pressure inside the chamber 110 may be determined according to the design dimensions of the battery cell 10.

Referring to FIGS. 6A to 6C, the side surface of the case 11 may have a concave or convex shape depending on the internal pressure of the battery cell 10. FIG. 6A illustrates the shape of the case 11 in an atmospheric pressure state, FIG. 6B illustrates the shape of the case 11 in an appropriate vacuum state, and FIG. 6C illustrates the shape of the case 11 in a high vacuum state. FIGS. 6A to 6C illustrate the shapes of the case 11 in a somewhat exaggerated form to clearly show the difference in respective pressures.

As illustrated in FIG. 6A, in an atmospheric pressure state, the case 11 may have a slightly convex shape by the first thickness T1 based on a flat state. As illustrated in FIG. 6B, in an appropriate vacuum state, the case 11 may have a slightly concave shape by a second thickness T2 based on a flat state. As illustrated in FIG. 6C, in a high vacuum state, the case 11 may have an excessively concave shape by a third thickness T3 based on a flat state. In the injection port sealing operation (S130), the pressure inside the chamber 110 may be set to a pressure at which the outer shape of the battery cell 10, for example, the outer shape of the case 11, has an appropriate shape according to the design dimensions of the battery cell 10.

Meanwhile, the degassing operation (S120) may include a process performed in a first negative pressure state, lower than the atmospheric pressure.

The pressure inside the chamber 110 in the first negative pressure state may vary. For example, the pressure inside the chamber 110 in the first negative pressure state is not limited to a fixed pressure value. As described above, the pressure inside the chamber 110 in the degassing operation (S120) may be controlled in multiple stages.

The injection port sealing operation (S130) may be performed in a second negative pressure state that is greater than the minimum pressure of the first negative pressure state and lower than the atmospheric pressure. The pressure inside the chamber 110 in the injection port sealing operation (S130) may have a value higher than the minimum pressure inside the chamber 110 in the injection port sealing operation (S130). For example, the vacuum level of the injection port sealing operation (S130) may be lower than the maximum vacuum level of the degassing operation (S120).

In the first negative pressure state, the pressure inside the chamber 110 may have a value of 10 torr to atmospheric pressure (for example, 760 torr), and in the injection port sealing operation (S130), the pressure inside the chamber 110 may have a value of 100 torr to 700 torr. For example, when a minimum value of the internal pressure of the chamber 110 in the first negative pressure state is 50 torr, the internal pressure of the chamber 110 in the second negative pressure state may have a value of 300 torr.

According to an embodiment, since the injection port sealing operation (S130) is performed in a negative pressure state, lower than the atmospheric pressure, deformation of the battery cell 10 may be prevented or reduced in the process of sealing the injection port 12a.

If the sealing plug is forcibly inserted or pressed into the injection port 12a while the battery cell 10 is exposed to atmospheric pressure, the pressure inside the battery cell 10 may increase, causing the battery cell 10 to deform. Accordingly, not only may the performance of the battery cell 10 deteriorate, but also the assembling efficiency may be reduced in the process of arranging the battery cell 10 to form a cell assembly.

On the other hand, according to an embodiment, since the injection port 12a is sealed in a negative pressure state where the internal pressure of the battery cell 10 is lower than the atmospheric pressure, deformation of the case 11 due to the increase in the internal pressure of the battery cell 10 may be prevented. In addition, since the internal pressure of the battery cell 10 is low, the pressing force required for the installation of the sealing plug 15 is small, and accordingly, not only is the installation of the sealing plug 15 easy, but deformation of the case 11 may be reduced.

In addition, according to an embodiment, since the pressure inside the chamber 110 may be controlled in the injection port sealing operation (S130), the degree of concaveness of the case 11 may be controlled. Therefore, according to an embodiment, a battery cell 10 satisfying the design dimensions may be easily manufactured.

In addition, according to an embodiment, since the degassing operation (S120) and the injection port sealing operation (S130) are performed continuously inside the chamber 110, the process of the battery cell 10 may be simplified.

Compared to the comparative example in which degassing is performed inside the chamber 110 and the injection port 12a is sealed outside the chamber 110, the embodiment may reduce the number of processes since degassing and injection port 12a sealing are performed continuously inside the chamber 110.

Furthermore, in the case of a comparative example in which the injection port 12a is sealed outside the chamber 110, since the injection port 12a is exposed to the outside air, the injection port 12a should be sealed in a dry room controlled to a low moisture level to prevent moisture infiltration through the injection port 12a. However, in the case of the embodiment, since the injection port 12a is sealed inside the chamber 110 in a negative pressure state, the sealing process may be easily performed.

The method of manufacturing a battery cell (S100) according to an embodiment may additionally include an injection port cover installation operation (S140) in which the sealing plug 15 is covered with an injection port cover 16.

The injection port cover 16 is configured to cover the sealing plug 15 to more stably block the inflow and outflow of gas or moisture through the injection port 12a. The injection port cover 16 may be provided as a metal plate and may be welded to the cap plate 12. However, the injection port cover 16 is not limited to this, and it is also possible to configure it to cover the sealing plug 15 with a sealing material such as silicone.

Referring to FIG. 7, the injection port cover installation operation (S140) may be performed by the injection port cover installer 150. The injection port cover installer 150 may include a welding device that welds (W) between the injection port cover 16 and the cap plate 12 in a state where the injection port cover 16 is disposed on the step portion 12b on the top of the injection port 12a.

Next, with reference to FIGS. 3 to 7, an apparatus 100 for manufacturing a battery cell according to an embodiment will be described. The apparatus 100 for manufacturing a battery cell according to an embodiment is an apparatus that may perform the method of manufacturing a battery cell (S100) described above. Therefore, the description of the method of manufacturing a battery cell (S100) described through FIGS. 1 to 7 may also be applied to the apparatus 100 for manufacturing a battery cell.

Referring to FIGS. 4 and 5, an apparatus 100 for manufacturing a battery cell according to an embodiment may include a chamber 110 that accommodates a battery cell 10 therein, a pressure regulator 120 that controls the flow of gas to control the pressure inside the chamber 110, a sealing plug installer 130 that covers an injection port 12a of the battery cell 10 with a sealing plug 15, and a controller 140 that controls the operation of the pressure regulator 120 and the sealing plug installer 130. The controller 140 may control the operation of the pressure regulator 120 so that the pressure inside the chamber 110 becomes a negative pressure state, lower than the atmospheric pressure during at least a portion of the degassing operation (S120) of discharging the gas inside the battery cell 10 and the injection port sealing operation (S130) of installing the sealing plug 15.

The chamber 110 may accommodate the battery cell 10 inside. The chamber 110 may include a vacuum chamber 110 capable of implementing a high vacuum state. The internal pressure of the chamber 110 may be controlled.

The pressure regulator 120 may control the flow of gas to control the pressure inside the chamber 110. The pressure regulator 120 may be connected to the chamber 110 to control the pressure inside the chamber 110. The pressure regulator 120 may include a vacuum pump that discharges gas (including air) (G) inside the chamber 110 to the outside. The pressure regulator 120 may include a gas supply that supplies gas inside the chamber 110 to control the pressure inside the chamber 110. The pressure regulator 120 may be connected to the inside of the chamber 110 through a gas flow line (LG). The pressure regulator 120 may be controlled by a controller 140.

The sealing plug installer 130 may cover the injection port 12a of the battery cell 10 with a sealing plug 15. The sealing plug installer 130 may approach the injection port 12a and supply the sealing plug 15 to the injection port 12a. With the sealing plug 15 positioned in the injection port 12a, the sealing plug installer 130 may forcefully fit or press the sealing plug 15 into the injection port 12a. Accordingly, the sealing plug 15 may seal the injection port 12a and block the internal space of the battery cell 10 from the outside. After the installation of the sealing plug 15 is completed, the sealing plug installer 130 may move away from the injection port 12a.

The controller 140 may control the operation of the pressure regulator 120 and the sealing plug installer 130. The controller 140 may control the operation of the pressure regulator 120 through the first control line LC1 and control the operation of the sealing plug installer 130 through the second control line LC2.

The controller 140 may control the operation of the pressure regulator 120 so that the pressure inside the chamber 110 becomes a negative pressure state, lower than the atmospheric pressure during at least a portion of the degassing operation (S120) for discharging gas inside the battery cell 10. In addition, the controller 140 may control the operation of the pressure regulator 120 so that the pressure inside the chamber 110 becomes a negative pressure state, lower than the atmospheric pressure during the injection port sealing operation (S130) for installing the sealing plug 15.

The controller 140 may cause the injection port sealing operation (S130) to be performed continuously with the degassing operation (S120). For example, the controller 140 may control the operation of the pressure regulator 120 and the sealing plug installer so that the injection port sealing operation (S130) starts at the end point of the degassing operation (S120). The controller 140 may control the operation of the pressure regulator 120 so that the pressure inside the chamber 110 is performed at a pressure higher than the final pressure of the degassing operation (S120) and lower than the atmospheric pressure in the injection port sealing operation (S130).

The controller 140 may terminate the degassing operation (S120) in a state where the inside of the chamber 110 has a high vacuum degree, and may perform the injection port sealing operation (S130) in a state where the inside of the chamber 110 has a lower vacuum degree than that in the degassing operation (S120). The controller 140 may control the operation of the pressure regulator 120 so that the injection port sealing operation (S130) is performed in a medium vacuum state when the degassing operation (S120) is terminated in a high vacuum state. For example, when the final pressure of the degassing operation (S120) is 100 torr, the injection port sealing operation (S130) may be performed at 400 torr.

The controller 140 may control the operation of the pressure regulator 120 so that the pressure inside the chamber 110 is lower than the atmospheric pressure in the degassing operation (S120). The controller 140 may control the operation of the pressure regulator 120 so that the pressure inside the chamber 110 is a second negative pressure state that is higher than the minimum pressure of the first negative pressure state and lower than the atmospheric pressure in the injection port sealing operation (S130).

The pressure inside the chamber 110 in the injection port sealing operation (S130) may have a value higher than the minimum pressure inside the chamber 110 in the injection port sealing operation (S130). For example, the vacuum degree of the injection port sealing operation (S130) may be lower than the maximum vacuum degree of the degassing operation (S120).

The pressure inside the chamber 110 in the first negative pressure state may have a value of 10 torr to the atmospheric pressure (for example, 760 torr), and the pressure inside the chamber 110 in the injection port sealing operation (S130) may have a value of 100 to 700 torr. For example, if the minimum value of the internal pressure of the chamber 110 is 50 torr in the first negative pressure state, the internal pressure of the chamber 110 may have a value of 300 torr in the second negative pressure state.

According to an embodiment, since the injection port 12a is sealed in the negative pressure state where the internal pressure of the battery cell 10 is lower than the atmospheric pressure, deformation of the case 11 due to an increase in the internal pressure of the battery cell 10 may be prevented. In addition, since the internal pressure of the battery cell 10 is low, the pressure required for installation of the sealing plug 15 is small, and accordingly, not only is the installation of the sealing plug 15 easy, but deformation of the case 11 may be reduced.

The controller 140 may control the operation of the pressure regulator 120 so that the pressure inside the chamber 110 in the injection port sealing operation (S130) has a pressure such that the external shape of the battery cell 10 has an appropriate shape according to the design dimensions of the battery cell 10.

The apparatus 100 for manufacturing a battery cell according to an embodiment may additionally include a liquid injector 160 as illustrated in FIG. 3. The liquid injector 160 may inject an electrolyte into the case 11 containing the electrode assembly 14 through an injection port 12a. The liquid injector 160 may approach the injection port 12a formed in the cap plate 12 and inject a preset amount of electrolyte (E) into the case 11 through the injection port 12a. When the injection of the electrolyte (E) is completed, the liquid injector 160 may be retracted in a direction away from the injection port 12a.

The apparatus 100 for manufacturing a battery cell according to an embodiment may additionally include an injection port cover installer 150 as illustrated in FIG. 7. The injection port cover installer 150 may cover the sealing plug 15 with the injection port cover 16. The injection port cover installer 150 may include a welding device that welds (W) between the injection port cover 16 and the cap plate 12 in a state where the injection port cover 16 is disposed on the step portion 12b on the top of the injection port 12a.

As set forth above, according to an embodiment, deformation of a battery cell may be prevented or reduced during a process of sealing an injection port.

According to an embodiment, a battery cell satisfying design dimensions may be manufactured.

According to an embodiment, a manufacturing process of a battery cell may be simplified.

Only specific examples of implementations of certain embodiments are described. Variations, improvements and enhancements of the disclosed embodiments and other embodiments may be made based on the disclosure of this patent document.

What is claimed is:

1. A method of manufacturing a battery cell, comprising:
an operation of injecting electrolyte into a case accommodating an electrode assembly, through an injection port;
a degassing operation of discharging gas inside the case; and
an injection port sealing operation of sealing the injection port,
wherein at least a portion of the degassing operation and the injection port sealing operation are performed inside a chamber under a negative pressure state, lower than atmospheric pressure.

2. The method of claim 1, wherein the injection port sealing operation is performed continuously with the degassing operation inside the chamber, and
the injection port sealing operation is performed at a pressure higher than a final pressure of the degassing operation and lower than atmospheric pressure.

3. The method of claim 1, wherein the degassing operation includes a process performed in a first negative pressure state, lower than atmospheric pressure, and
the injection port sealing operation is performed in a second negative pressure state, higher than a minimum pressure of the first negative pressure state and lower than atmospheric pressure.

4. The method of claim 1, wherein in the degassing operation, pressure inside the chamber has a value of 10 torr to atmospheric pressure, and
in the injection port sealing operation, the pressure inside the chamber has a value of 100 to 700 torr.

5. The method of claim 1, wherein in the degassing operation, pressure inside the chamber is controlled in multiple stages.

6. The method of claim 1, wherein the injection port sealing operation includes a process of installing a sealing plug in the injection port.

7. The method of claim 6, wherein the method further comprises an injection port cover installation operation of covering the sealing plug with an injection port cover.

8. The method of claim 1, wherein the degassing operation and the injection port sealing operation are performed with the case being located inside the chamber.

9. An apparatus for manufacturing a battery cell, comprising:
a chamber accommodating a battery cell therein;
a pressure regulator regulating a flow of gas to control pressure inside the chamber;
a sealing plug installer covering an injection port of the battery cell with a sealing plug; and
a controller controlling an operation of the pressure regulator and the sealing plug installer,
wherein the controller controls the operation of the pressure regulator such that the pressure inside the chamber becomes a negative pressure state, lower than atmospheric pressure during at least a portion of the degassing operation of discharging gas inside the battery cell and the injection port sealing operation of installing the sealing plug.

10. The apparatus of claim 9, wherein the controller controls the injection port sealing operation to be performed continuously with the degassing operation, and
the controller controls the operation of the pressure regulator so that the injection port sealing operation is performed at a pressure at which the pressure inside the chamber is higher than a final pressure of the degassing operation and lower than atmospheric pressure.

11. The apparatus of claim 9, wherein the controller controls the operation of the pressure regulator so that the pressure inside the chamber is in a first negative pressure state, lower than atmospheric pressure, in the degassing operation, and
the controller controls the operation of the pressure regulator so that the pressure inside the chamber is in a second negative pressure state, higher than a minimum pressure of the first negative pressure state and lower than atmospheric pressure in the injection port sealing operation.
